(19) United States
(12) Patent Application Publication
(10) Pub. No.: US 2004/0113394 A1
(43) Pub. Date: Jun. 17, 2004

(54) Supporting mechanism of a foldable stroller

(76) Inventor: Pao-Hsien Cheng, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/316,008

(22) Filed: Dec. 11, 2002

(51) Int. Cl. B62B 9/00

(52) U.S. Cl. 280/647

(57) ABSTRACT

A supporting mechanism of a foldable stroller includes a connecting member, and a supporting rod. The connecting member is joined to a frame of the stroller, and has a connecting portion sticking out from the frame. The supporting rod is movably passed through the connecting portion of the connecting member, and is pivotally connected to a pivotal portion of the frame at an upper end thereof so that when the stroller is in a folded position, under which the orientation of the pivotal portion relative to other parts of the frame is different from that under a stretched position of the frame, a lower end of the supporting rod can support the stroller in an upright position together with rear wheels of the stroller.

### BACKGROUND OF THE INVENTION

1. Field of the Invention

The present invention relates to a supporting mechanism of a foldable stroller, more particularly a supporting mechanism, which can support the stroller stably in an upright position together with rear wheels of the stroller when the stroller is in folded position.

2. Brief Description of the Prior Art

Conventional foldable strollers are either not provided with any supporting mechanism for supporting them stably in a folded position or made to stand, after they are folded, in upright position on front and rear wheels thereof on the ground. However, strollers are prone to unwontedly move around if they are supported on the ground by means of the front and rear wheels after they are folded.

### SUMMARY OF THE INVENTION

It is a main object of the present invention to provide a supporting mechanism to a foldable stroller so that a lower end of a supporting rod thereof can support the stroller in an upright position together with rear wheels of the stroller after the stroller has been folded.

The supporting mechanism is arranged in such a way that the lower end of the supporting rod thereof won't project too far away from the frame of the stroller to cause people to trip when supporting the stroller, folded, in upright position. In other words, the lower end of the supporting rod is relatively close to the frame when supporting the stroller in upright position, not possibly to cause increase to the size of the stroller.

### BRIEF DESCRIPTION OF THE DRAWINGS

The present invention will be better understood by reference to the accompanying drawings, wherein

FIG. 1 is a partial exploded perspective view of the supporting mechanism of a foldable stroller according to the present invention,

FIG. 2 is another partial exploded perspective view of the supporting mechanism of a foldable stroller according to the present invention,

FIG. 3 is a perspective of a foldable stroller equipped with the supporting mechanism of the present invention,

FIG. 4 is a partial side view of a foldable stroller, equipped with the supporting mechanism of the present invention and in stretched position,

FIG. 5 is a partial side view of a foldable stroller, equipped with the supporting mechanism of the present invention and in folded position,

FIG. 6 is a partial rear view of a foldable stroller, equipped with the supporting mechanism of the present invention and in folded position; and,

FIG. 7 is a view illustrating removal of the supporting mechanism of the present invention from the stroller.

### DETAILED DESCRIPTION OF THE PREFERRED EMBODIMENTS

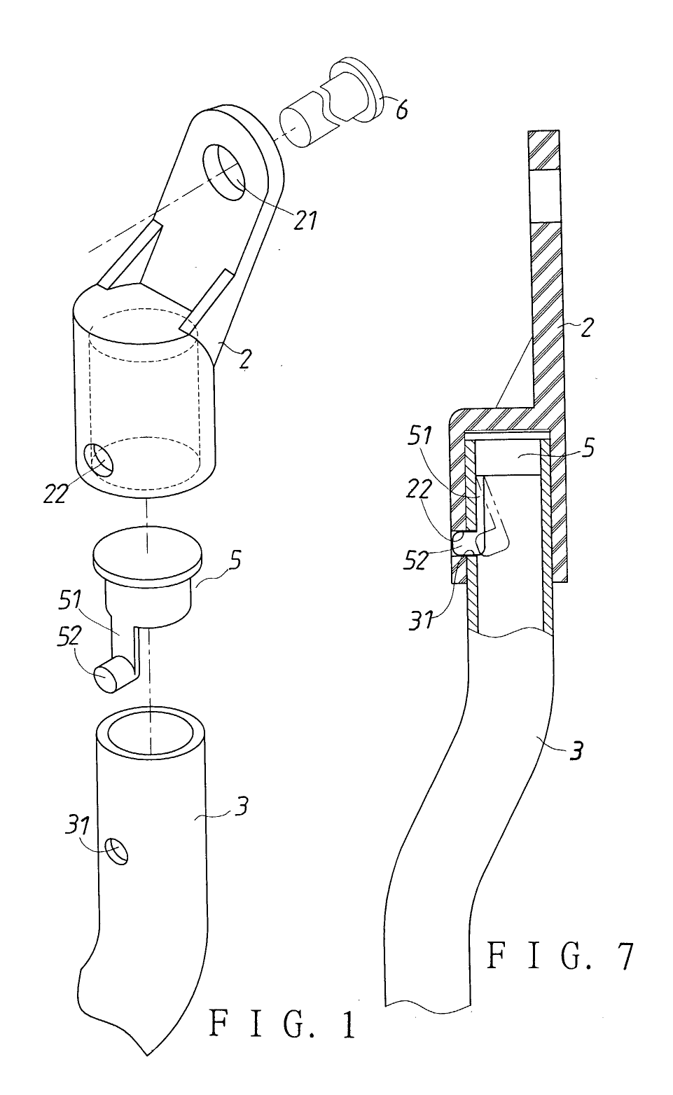

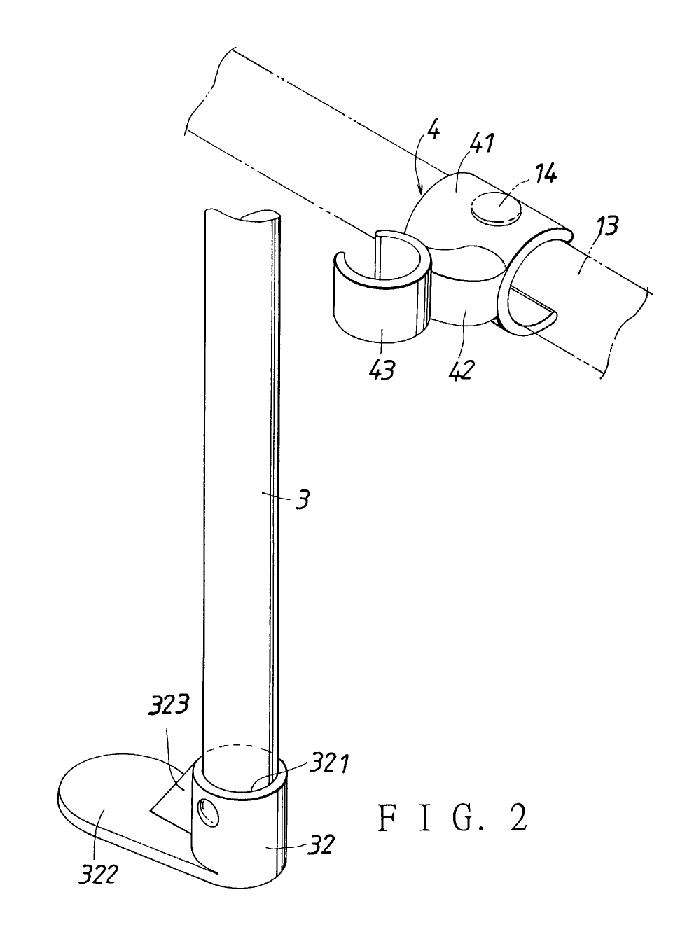

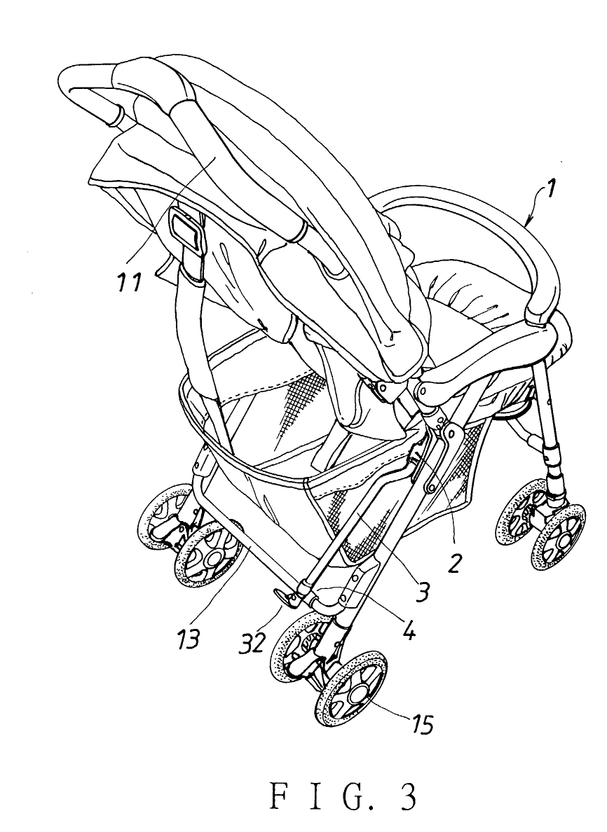

Referring to FIGS. 1, 2, and 3, a supporting mechanism of a foldable stroller according to the present invention includes a joining member 2, a supporting rod 3, and a connecting member 4.

The connecting member 4 includes a middle portion 42, first and second connecting portions 43, 41 formed at two ends of the middle portion 42. The connecting portions 43, 41 are formed with a ring-shaped cross-section, and are preferably formed with a gap so that cross-sectional views thereof are like a “C”.

The supporting rod 3 has an engaging hole 31 on a lateral side of an upper end thereof. There is a foot member 32 connected to a lower end of the supporting rod 3; the foot member 32 includes a bottom plate 322 provided for increasing area of contact of the foot member 32 with the ground, and a connecting portion 321, which sticks up from the bottom plate 322, and which has a holding room; the lower end of the supporting rod 3 is inserted into the holding room, and fixed to the connecting portion 321 by fixing means. In addition, the foot member 32 has a strengthening plate 323 connected to both the connecting portion 321 and the bottom plate 322 thereof.

The joining sleeve 2 consists of a main body, an extension part, and a locking member 23; the extension part has a through hole 21; the main body has a holding room, and a through engaging hole 22 in communication with the holding room. The locking member 23 includes a flexible plate 231, and an engaging protrusion 232 sticking out from an outward side of a lower end of the flexible plate 231.

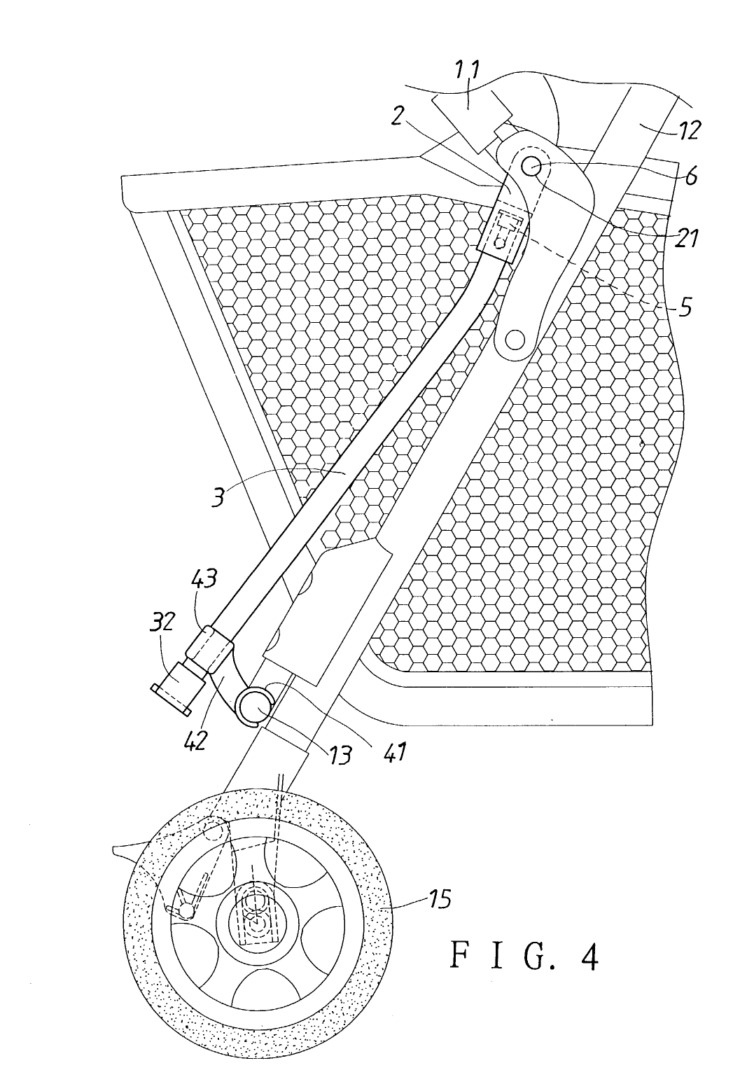

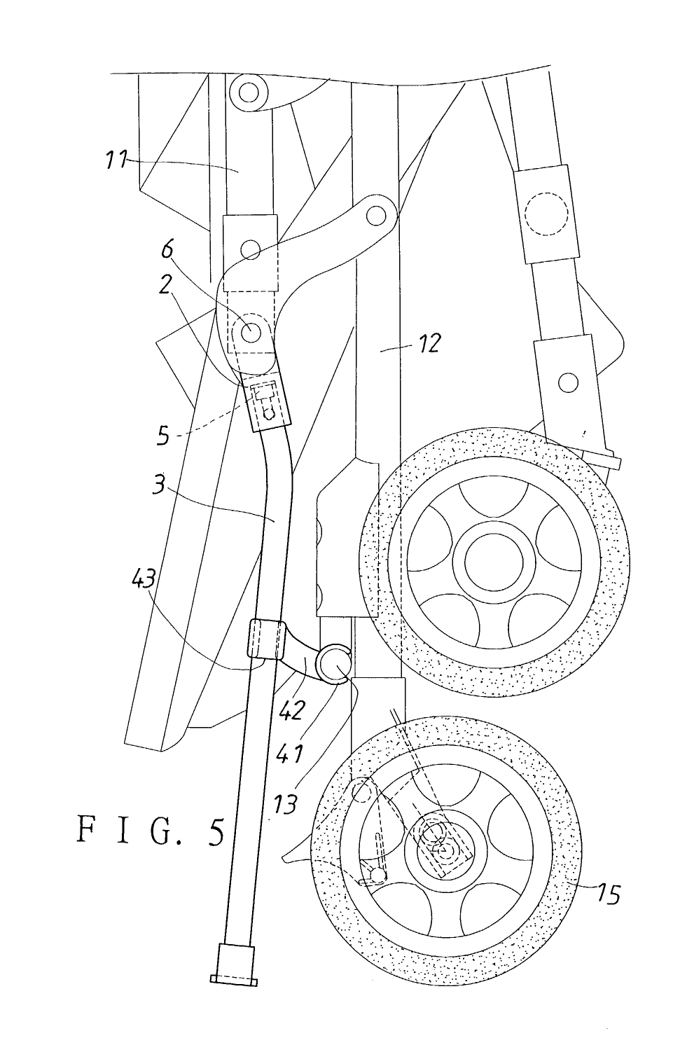

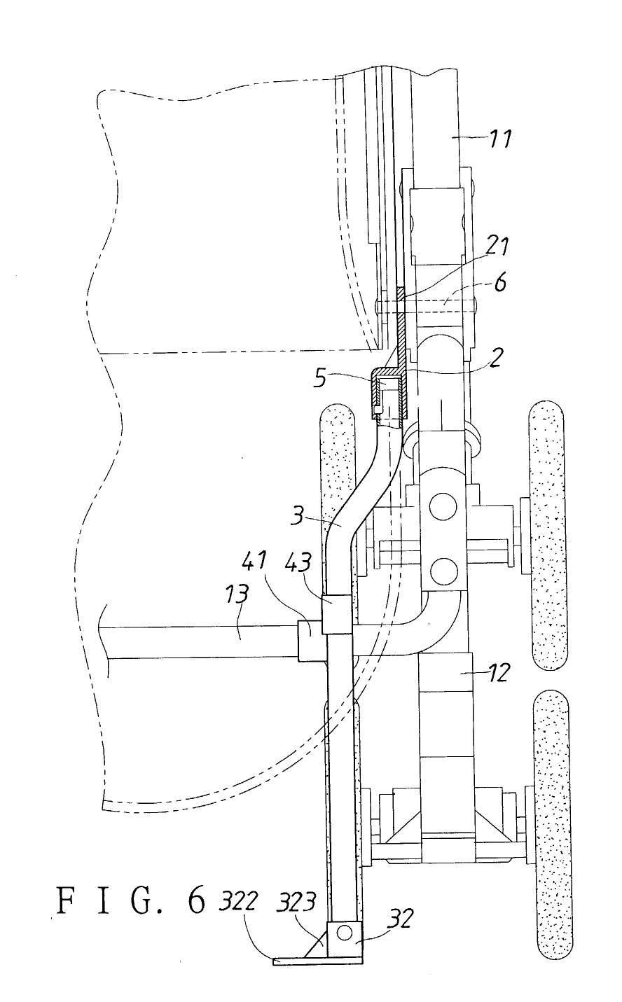

In combination, the locking member 23 is inserted into the upper end of the supporting rod 3 with the engaging protrusion 232 thereof sticking out from the lateral engaging hole 31 of the supporting rod 3, and the upper end of the supporting rod 3 is passed into the holding room of the joining sleeve 2 with the engaging protrusion 232 snapping into the through engaging hole 22 of the joining sleeve 2., The second connecting portion 41 of the connecting member 4 is fitted around a rear portion of a frame 1 of a stroller, e.g. a transverse rod 13, which is connected to a pair of rear supporting rods 12 (FIG. 4) of the stroller frame 1 at two ends. A pivotal pin 6 is passed through the through hole 21 of the joining sleeve 2, and connected to a pivotal portion of the frame 1, e.g. one lower end of a handle 11 of the stroller frame 1; when the stroller frame 1 is moved to a folded position, orientation of the pivotal portion of the frame 1 relative to other parts of the frame 1 is different from that under a stretched position of the frame 1, as shown in FIGS. 4, and 5. And, the supporting rod 3 is movably passed through the first connecting portion 43 of the connecting member 4.

Thus, the supporting rod 3 slides down relative to the connecting member 4 when the stroller is being folded, and the foot member 32 of the lower end of the supporting rod 3 can support the stroller in an upright position together with rear wheels 15 of the stroller after folding operation of the stroller is completed.

Because the supporting rod 3 is connected to the connecting member 4, and the connecting member 4 is joined to the rear transverse rod 13 of the frame 1, the supporting rod 3 can be moved together with the rear transverse rod 13 and the rear supporting rods 12 when the stroller is being folded. Therefore, the supporting rod 3 won't interfere with folding operation of the stroller.

When the supporting rod 3, together with the rear wheels 15, supports the folded stroller in upright position, it will only form a relatively small angle with a vertical line, i.e. the supporting rod 3 is only slightly tilted, because the lower end of the handle 11, to which the upper end of the supporting rod 3 is pivoted, is at a relatively long distance from the transverse rod 13. Therefore, the lower end of the supporting rod 3 won't project too far away from the frame 1 to cause people to trip when the supporting rod 3 supports the stroller, folded, in upright position. And, because the lower end of the supporting rod 3 is relatively close to the frame 1 when the supporting rod 3 supports the folded stroller in upright position, the present supporting mechanism can't cause increase to the dimensions of the stroller, and size of packing boxes of the present stroller won't have to be increased for the supporting rod 3.

Furthermore, referring to FIG. 7, should the supporting rod 3 be damaged and need to be fixed or replaced with a new one, the engaging protrusion 232 is pressed so that the locking member 23 is disengaged from the engaging hole 22, and the supporting rod 3 and the locking member 23 are detached from the main body of the joining sleeve 2.

From the above description, it can be understood that the supporting mechanism of the present invention is relatively easy to use, and uncomplicated in structure, and can't cause people to trip over or cause increase of size of packing boxes of a stroller.

What is claimed is:

1. A supporting mechanism of a foldable stroller, comprising
a connecting member joined to a frame of a stroller; the connecting member having a first connecting portion sticking out from the frame; and,
a supporting rod, the supporting rod being movably passed through the first connecting portion of the connecting member; the supporting rod being pivotally connected to a pivotal portion of the stroller frame at an upper end thereof so that when the stroller frame is in a folded position where orientation of the pivotal portion relative to other parts of the frame is different from that under a stretched position of the frame, a lower end of the supporting rod is capable of supporting the stroller in an upright position together with rear wheels of the stroller.

2. The supporting mechanism of a foldable stroller as claimed in claim 1, wherein a joining sleeve is detachably connected to the upper end of the supporting rod, and is pivoted to the pivotal portion of the stroller frame.

3. The supporting mechanism of a foldable stroller as claimed in claim 2, wherein the joining sleeve consists of a main body, and a locking member; the main body having a holding room, and a through engaging hole in communication with the holding room; the locking member including a flexible plate, and an engaging protrusion sticking out from an outward side of the flexible plate; the locking member being inserted into the upper end of the supporting rod with the engaging protrusion sticking out from a lateral engaging hole of the supporting rod; the upper end of the supporting rod being passed into the holding room with the engaging protrusion of the locking member snapping into the through engaging hole of the joining sleeve.

4. The supporting mechanism of a foldable stroller as claimed in claim 1, wherein a foot member is joined to the lower end of the supporting rod.

5. The supporting mechanism of a foldable stroller as claimed in claim 4, wherein the foot member has a connecting portion having a holding room, and the lower end of the supporting rod is inserted into the holding room, and fixed to the connecting portion.

6. The supporting mechanism of a foldable stroller as claimed in claim 4, wherein the foot member has a bottom plate connected to a lower end of the connecting portion thereof for increasing area of contact of the foot member with a ground.

7. The supporting mechanism of a foldable stroller as claimed in claim 6, wherein the foot member has a strengthening plate connected to both the connecting portion and the bottom plate thereof.

8. The supporting mechanism of a foldable stroller as claimed in claim 1, wherein the pivotal portion of the stroller frame is a handle of the stroller, and the supporting rod is pivoted to a lower end of the handle.

9. The supporting mechanism of a foldable stroller as claimed in claim 2, wherein the pivotal portion of the stroller frame is a handle of the stroller, and the joining sleeve is pivoted to a lower end of the handle at an upper end thereof.

10. The supporting mechanism of a foldable stroller as claimed in claim 1, wherein the first connecting portion of the connecting member has a ring-shape, and the connecting member is connected to the stroller frame at a second ring-shaped portion thereof.

11. The supporting mechanism of a foldable stroller as claimed in claim 10, wherein the second ring-shaped portion of the connecting member is fitted around a transverse rod, which is connected to a pair of rear supporting rods of the stroller frame at two ends.

12. The supporting mechanism of a foldable stroller as claimed in claim 10, wherein each of the first and the second ring-shaped portions of the connecting member is formed with a gap to have a C-shaped cross-section.

13. The supporting mechanism of a foldable stroller as claimed in claim 1, wherein the first connecting portion of the connecting member is formed with a C-shape.
